(19) United States
(12) Patent Application Publication
(10) Pub. No.: US 2014/0114590 A1
(43) Pub. Date: Apr. 24, 2014

(54) LEAK DETECTION AND LOCATION SYSTEM AND METHOD

(71) Applicant: Clark Robert Gunness, Nashville, TN (US)

(72) Inventor: Clark Robert Gunness, Nashville, TN (US)

(21) Appl. No.: 14/061,480

(22) Filed: Oct. 23, 2013

Related U.S. Application Data
(60) Provisional application No. 61/717,455, filed on Oct. 23, 2012.

(51) Int. Cl. G01M 3/40

(52) U.S. Cl. CPC G01M 3/40
USPC 702/51

(57) ABSTRACT

A signal unit, system and method for leak detection and location in a membrane using varying signals with a low density sensor array.

### CLAIM OF PRIORITY

This application claims the benefit of priority of U.S. Provisional Patent Application Ser. No. 61/717,455, filed on Oct. 23, 2012.

### FIELD OF THE INVENTION

The present invention relates to the detection and location of water leakage in structures, and in particular to computer controlled leakage detection and location systems.

### BACKGROUND

Roof and waterproofing membranes and linings have long been used to protect buildings, to contain water in ponds and decorative water features, to prevent leaching of contaminants from landfills, and for other purposes. While these membranes have utility, leakage through the membranes is an ongoing problem. The efforts to contain and locate leakage have resulted in the rise of specialized consultants, air and vacuum testable membranes, and, in recent history, electrical testing methods that not only determine if a leak is present in a membrane system, but where the leak is located. Tests have been created for various elements of the building weather envelope, including tests for window walls, curtain walls, doors, windows, air barriers, and the roofing and waterproofing seals that protect the building from water. This interest in having long-lasting and reliable structures and systems to shield the building from the elements has created a number of automatic leak detection and performance systems, not just for the walls of the building or the windows, but also for the roofing and waterproofing systems.

The first automatic systems for monitoring the condition of roofing membranes were created by Progeo GmbH in Germany in the late 1990s. These systems relied on a mildly conductive glass or nonwoven felt and sensors spaced approximately ten feet apart in a grid pattern. These systems, known as Smartex PEEL systems, were applied under the membrane while the roof was being constructed and relied on the electrical resistance of the membrane to shield the sensors under the membrane from an electrical signal generated by the system on top of the membrane. If the membrane leaked anywhere on its surface, the water entering the leak would touch the conductive felt and would carry the signal current from the top surface of the membrane to underneath the membrane, which signal would then be detected by the sensors deployed under the membrane and the signal strength as measured by the sensors would be relayed to the controlling computer.

These systems have worked very well and, over the past fifteen years, have been used not only in building applications, but also in civil applications such as landfills, lagoons, and other large civil structures. The system works by using a moderately conductive felt made from a nonmetallic material such as glass, polypropylene, or polyethylene nonwoven felts. The moderately conductive properties of these felts provide a resistance to the signal as it travels along the felt to the sensor, causing each sensor to see a certain reduced voltage from that which is present on the top of the roof. The further the sensor is away from the opening in the roof, the less voltage it sees.

With ten foot spacing, and given the moderate conductivity of the felt which overlies the sensors and which is in contact with the membrane, the system is able to accurately locate leaks within approximately one foot of where the water is actually entering. Although there are applications where the exact location of a leak is required, it is not always possible for a roofer or building maintenance personnel to go up on the roof and exactly locate the source of leakage as shown on a computer screen, especially if the membrane is covered with overburden such as insulation and stone, pavers, or green roofing. As a result, in normal applications, the exact location of leakage in the membrane often becomes secondary to just knowing that the membrane is leaking and being able to identify the location of the leak within approximately five feet.

The density of the sensors and the required hubs to which the sensors are connected, when taken in relation to the accuracy required to physically find a leak on a roof, make the system less cost effective than it could be if the density of the sensors were decreased by spacing the sensors further apart. However, increasing the distance between sensors creates its own issues. One issue that is created when the sensors are spaced further apart, or have lower density, is that the signal generated by normal testing voltage attenuates too quickly in the moderately conductive felt for the less dense sensor array to actually read a significant amount of voltage difference. Indeed it is possible that the sensors, now located some distance from where the signal source (e.g. a roof leak) occurs, will not see any voltage at all, so triangulation of the leak cannot occur. Even if one sensor is near enough to the leak to detect the signal, triangulation is still not possible as the direction that the leak is located from that individual sensor cannot be known unless two other sensors gathering reliable data are involved. The farther the sensor is from the source of the signal, the less reliable the data becomes.

In the above described case, sensors that are close to the leak in the membrane do see the voltage and, depending on how far each individual sensor is located from the hole in the membrane, meaningful measurement of attenuation and triangulation can occur. However, in this scenario, it is important that the voltage be high enough to reach the sensors before attenuation makes the signal so small that variations cannot be effectively measured, but low enough to attenuate significantly so that the graph representing the attenuation over a measured distance has enough slope, showing loss of energy, that the values of the slope can be measured by the different sensors and compared and used for triangulation by the computer.

Increasing the voltage can be a solution to this problem, and voltages up to 58 volts might be generated in order to overcome the natural resistance of the conductive medium and reach sensors now located much further from the source of the signal. However, greater voltage creates the opposite problem. When sensors are closer to the leak in the membrane, the increased current or signal is so strong that very little measurable attenuation of the signal occurs for some distance. In this instance, therefore, a stronger signal allows sensors that are considerably far removed from the leak to measure meaningful drops in the voltage, but the close triangulation from sensors far removed from the leak would cover a broad area of the roof at best or, at worst, identify the location of the leak somewhere on the roof other than where the leak actually is because of variances in measuring voltage drop.

Therefore, there is a need for a system that uses lower density sensors but adequately addresses the issues outlined above. Various electrical testing methods and systems that determine both that a leak is present in a membrane system, and where the leak is located, but that do not address these issues, are disclosed in the Inventor's U.S. Pat. No. 8,566,051 and co-pending U.S. patent application Ser. No. 13/442,586, each of which are hereby incorporated by reference.

### SUMMARY OF THE INVENTION

The present invention is a signal unit, system and method for detecting and locating leaks in membranes.

In its most basic form, the first embodiment of the system of the present invention includes a sensor array, a signal generator, and a computer with a signal control in electrical communication with the sensor array and the signal generator. The signal generator is capable of generating an electrical field by providing a pulse or continuous signal over the surface of a membrane to be tested. The membrane may be a roofing or waterproofing membrane, for example. Reference herein to a “membrane” may refer to any such type of membrane. Moreover, reference herein to a “signal” is understood to refer to a pulse of any length or a continuous signal, and the signal may be measured in terms of voltage, frequency, or other measure, as described in more detail below. The signal generator receives instructions from the computer as to what type of signal to provide. The signal generator is preferably an impulse cable that need only lie proximate to the sensor array to provide signals readable by the sensors of the sensor array. It is not necessary that the signal generator be a loop around the sensor array, for example. In some embodiments, however, the signal generator provides voltage to a wire boundary loop surrounding the sensor array, thus creating an electric field over the area to be tested. The signal generator may be a portable device able to be integrated with any number of different types of systems. The signal generator may also be a permanent fixture on a membrane to be tested that is in permanent communication with the system of the present invention designated for that application.

The sensor array is preferably laid out in a low density grid where the sensors are 12 to 60 feet away from one another. The sensors may be on top of or below the membrane to be tested but corresponds to an area to be tested on the membrane. Each sensor is capable of detecting a voltage of the electrical field at the location of the individual sensor and relaying this information to the computer. The sensor array may be physically wired to the computer, but may also send the information wirelessly.

The signal control is an electrical or electronic control capable of varying the voltage, frequency, or voltage and frequency of the signal provided by the signal generator. The voltage, the frequency, and the voltage and frequency of the signal may collectively be referred to as the “strength” of the signal. The signal control is preferably integrated with the computer, the signal generator, or both, but may also be a separate unit in electrical communication with the computer and the signal generator. The signal control instructs the signal generator as to what type of signal to provide based upon a result obtained from the software product.

The computer is capable of reading a state of the electrical field created by the signal generator through the information provided from the sensors in the sensor array. The computer preferably includes a hub assembly for physical wiring to the sensor array and signal generator.

In some embodiments, however, all information and instructions are communicated between the sensor array, the signal generator, and the computer wirelessly. In other embodiments, one of the sensor array or the signal generator is physically wired to the computer and the other is not. In some embodiments, there is physical wiring but no specific hub assembly as in the preferred embodiment. The computer may be any type of computer, including a device with no functionality beyond that necessary to perform the functions described herein. The computer stores the software product of the present invention and performs those steps of the method of the present invention when the software product is executed.

The computer mixes combinations of low and high voltage and frequency signals in order to locate leaks in the membranes as exactly as if the sensors were closely spaced. The computer executes a software program of the present invention that instructs the performance of a method of the present invention.

In a basic embodiment, the signal control instructs the signal generator to first provide a low voltage pulse, 7 volts, for example. The sensors are then polled. The the signal control then instructs the signal generator to provides a higher voltage pulse, 15 volts, for example. The length of the pulse may be of any length common in the art. The sensors are then polled again.

In a preferred embodiment, each sensor is polled in turn after the signal generator provides the first signal, and then each sensor is polled in turn after the signal generator provides the second signal. In a variation of this preferred embodiment, the first sensor in the array is polled after the first signal is provided, then the first sensor is polled after the second signal is provided, then the second sensor in the array is polled after the first signal is provided, then the second sensor is polled after the second signal is provided, then the third sensor in the array is polled after the first signal is provided, etc. . . . In other embodiments, all sensors are simultaneously polled after the first signal is provided and then all sensors are simultaneously polled after the second signal is provided. In yet other embodiments, more than two voltage or frequency levels might be provided with the sensors being polled as described above as these additional voltage levels are generated.

With the first, lower voltage pulse, the signal will attenuate very quickly and only sensors fairly close to a leak will detect a voltage. Sensors farther away from the leaks may not detect any voltage at all. With the sensors spaced far away from one another as with the preferred low density sensor array, it is unlikely that enough sensors would detect a voltage with the first, lower voltage pulse for the leak to be located by triangulation. In a situation where only one sensor detects a voltage, it is known that there is a leak proximate to the sensor, but it is not known in what direction the leak is from the sensor. With the second, higher voltage pulse, the signal will not attenuate so quickly, so several sensors may detect the same voltage before the signal attenuates. Therefore a larger area surrounding those sensors is indicated as being where the leak is located. This information garnered after the higher voltage pulse about the larger area, combined with the information garnered after the lower voltage pulse about the smaller area will be sufficient to locate the leak.

In some embodiments, the system also includes an intrinsically conductive medium disposed under the membrane to be tested. The conductive medium is preferably a felt, mesh, screen, netting, such as hex netting, scrim, or foil but may be other more or less conductive materials commonly used in the art. The other elements of the system, particularly the sensors and the impulse cable or cables may be disposed on top of or underneath the membrane to be tested. In those embodiments where the system elements are disposed under the membrane, it is preferable that the system also include the conductive medium.

The system of the present invention therefore addresses triangulation problems experienced by sensors that have a low density by a combination of strong and weak signals. The strong signal allows outlying sensors to measure the voltage. With the one or more weaker signals, closer lying sensors are not overpowered by a strong signal that renders them unable to measure the attenuation of the voltage. Therefore, the sensors can measure attenuation of the voltage from the weaker signals entering through the leak. The computer receives all the data and, using a paradigm that allows triangulation in relation to and within the relationships of the different signals, generates a leak alert and locates the leak almost as exactly as if the sensors were closely spaced.

Preferred versions of this system add to the basic functionality. For example, in the preferred system, if each of the sensors in the sensor array detect approximately the same voltage after the first, lower voltage pulse, indicating a steady electrical state, then no leak is present, and no second, higher voltage pulse is necessary or provided. Also, if enough information can be gathered from the sensors after the first, lower voltage pulse, to locate the leak, then no second, higher voltage pulse is necessary or provided. Moreover, if no sensors detect a voltage after the first, lower voltage pulse, then an intermediate voltage pulse having a voltage somewhere between the lower voltage and higher voltage pulses is provided either before or after the higher voltage pulse. Similarly, if the higher voltage pulse is not detected by enough sensors, an even higher voltage pulse may be provided. Voltage pulses may be up to 58 volts, which may be necessary over non-conductive substrates, as discussed in more detail below. In short, the system may continue varying the voltage pulse until enough information is provided to locate the leak.

In addition, when a leak is detected, the system may only poll the sensors known to be proximate to the leak after the second signal, rather than polling each sensor in the sensor array. For example, after the first signal, all sensors are polled and only one sensor measures a voltage. This indicates a leak, as all sensors would measure approximately the same voltage if the electrical field were steady, as it would be in the absence of a leak. Then after the second signal, only the sensor that measured a voltage after the first signal, and sensors proximate to that sensor will be polled. They will be polled in a logical order gradually moving away from the sensor that measured voltage after the first signal until enough information is gathered from enough proximate sensors to locate the leak. Polling fewer sensors after the second signal makes the system more efficient and reduces the amount of data storage needed.

There are several variations on the basic embodiment described above. The frequency of the signal may be modified, rather than the voltage, for example. In addition, a combination of varied frequencies and voltages may be used. Moreover, it is known that electrical currents can overlay one another and, while sharing the same conductor, can maintain their characteristics as distinguished by a receiver at the other end of the conductor. Therefore the signal generator may provide a first signal at a certain voltage or frequency, the sensors may be polled at that first voltage or frequency level, and then the voltage or frequency may be varied without shutting off the first signal, and the sensors may polled again at the new voltage or frequency.

Preferred embodiments of the system of the present invention are also modifiable to account for the conductivity of a specific membrane to be tested. For almost non-conductive surfaces, such as asphalt, for example, higher voltages or frequencies would need to be programmed because the signals will tend to attenuate very quickly. On the other hand, the systems of the present invention may also be used on conductive building materials, such as metallic substrates, by using considerably lower voltages, as attenuation of the signal would require a very low amount of energy in order to be measured. This is an advantage of the present system over some prior art systems that require a non-conductive membrane to be applied over any conductive substrates in order to operate. Therefore, the nature of the membrane to be tested may dictate the values of the varying voltages and frequencies used by the first system of the present invention.

In some embodiments, the system may allow input concerning the conductivity of the substrate to be tested so as to appropriately calibrate the level of the signals for that substrate. This input may be manually entered by an operator. Alternatively, the system may perform tests to check the conductivity of the substrate and gain the necessary input in this manner.

The system of the present invention may be designed to accommodate almost any density of sensors. This allows the system of the present invention to be applied to irregularly shaped surfaces and locations that cannot be addressed by prior art systems. Further, as discussed below, the signal unit of the present invention may be readily adapted to use with prior art systems to enhance the performance thereof by utilizing the variable voltage testing method of the present invention.

In its most basic form, the signal unit of the present invention is a combination of the signal control and the computer described above in connection with the system of the present invention.

The signal unit may be used to vary the signals provided during use with prior art systems. Further, the software product stored within the signal unit may be adapted such that each of the functions described above may be instructed for performance by the prior art systems. Indeed, in some embodiments, the signal unit is the combination of the software product and an output from a prior art computer that runs the software product of the present invention. This allows the signal unit to be used with a variety of prior art systems for locating and detecting leaks.

In preferred embodiments, the signal unit also includes a signal generator capable of providing the varying signals that are the basis of the present invention. Again, this will depend on the nature and capabilities of the system with which the signal unit of the present invention is being used. The signal unit will instruct either the integrated signal generator, or a usable signal generator of the prior art system, to provide varying signals in order to locate the leak as described above.

In some embodiments of the present invention, the signal unit is part of a computer, as described above. The computer may be integrated with or may replace the computer or controller of the prior art system. In such embodiments, the computer may also include a hub assembly specific to the prior art system with which the second system is being used so that the computer may be easily integrated into the prior art system. The hub assembly included in the second system may, for example, include appropriate connectors for putting a sensor array and/or signal generator of the prior art system in electrical communication with the computer of the second system of the present invention. The second system of the present invention therefore may be used in connection with systems such as those disclosed in the Inventor's U.S. Pat. No. 8,566,051 and co-pending U.S. patent application Ser. No. 13/442,586 and other systems, such as those used by Progeo® Monitoring of North America, for example and the widely used methods described in U.S. Pat. No. 4,565,965 by Geesen. When the second system of the present invention is used in combination with the systems disclosed in the Inventor's U.S. Pat. No. 8,566,051 and co-pending U.S. patent application Ser. No. 13/442,586, the sensors in those systems may be spaced much farther apart.

The methods of the present invention mirror the functions of the systems of the present invention as described above. Specifically, in its most basic form, the method of the present invention includes the steps of the computer indicating to the signal control to vary an electrical signal to a first strength; the signal control varying the electrical signal to the first strength; the signal generator providing the electrical signal with the first strength to the membrane; the computer polling the sensors for the electrical signal strength at the positions of the sensors on the membrane; the computer determining that insufficient data has been received to determine a location of a leak in the membrane; the computer indicating to the signal control to vary an electrical signal to a second strength, wherein the second strength is distinct from the first strength; the signal control varying the electrical signal to the second strength; the signal generator providing the electrical signal with the second strength to the membrane; the computer polling the sensors for the electrical signal strength at the positions of the sensors on the membrane; the computer determining that sufficient data has been received to determine a location of a leak in the membrane; and the computer issuing an alert indicating the presence and location of the leak.

This method may be varied as described above with respect to the first system: If no sensor detects a voltage after the first signal, then an intermediate signal may be provided before or after the higher signal. If every sensor detects the same voltage after the first signal, then no further signals are provided. If enough information is provided from the polling after the first signal to locate the leak, then no further signals are provided. Frequency of the signal may be varied, rather than voltage. The distinct signals may not be two separated signals, but rather one signal that is then varied without being shut off. The value of the voltage or frequency variations may be determined based on the conductivity of the membrane to be tested. The sensors may be selectively polled after the second signal so as to only poll those sensors proximate to the sensor or sensors that measured a voltage after the first signal.

The method is preferably performed by a software product that is stored in the computer or signal control and instructs the signal control signal generator and computer to perform the steps of the method of the present invention. The software product includes software code for performing each of the steps and step variations included above. Further, in some embodiments, the signal control takes the form of the software product, which is stored and executed by the computer or controller of a prior art system.

Currently, sensors within a sensor array are usually no farther apart from one another than 10 to 15 feet. The method, software program, and systems of the present invention may allow for distances of up to 60 feet apart or more between the sensors in the sensor array. This would be a vast savings in the number of sensors needed within an array and the cost and effort of installation and maintenance of an array.

Therefore it is an aspect of the present invention to provide a system for detecting and locating a leak in a membrane with a low density sensor array.

It is a further aspect of the present invention to provide a system that can vary either or both the frequency or voltage of a signal in order to produce at least two distinct signals.

It is a further aspect of the present invention to provide a system that uses information about an electrical field created by two distinct signals in order to locate a leak with only a low density sensor array.

It is a further aspect of the present invention to provide a system for detecting and locating a leak on irregularly shaped surfaces.

It is a further aspect of the present invention to provide a system for detecting and locating a leak over substrates having a wide range of conductivity.

It is a further aspect of the present invention to provide a signal unit for varying signals to be used in conjunction with prior art systems for leak detection and location.

It is a further aspect of the present invention to provide a method for varying signals in order to detect and locate leaks with a low density sensor array.

It is a further aspect of the present invention to provide a software product instructing the method of the present invention for execution by the systems of the present invention.

### BRIEF DESCRIPTION OF THE DRAWINGS

FIG. 1 shows a plan of an installation with low sensor density and a low voltage signal.

FIG. 2 shows a plan of an installation with low sensor density and a high voltage signal.

FIG. 3 shows a plan of an installation with low sensor density and a combination of low and high voltage signals.

FIG. 4 is a block diagram showing the components of one embodiment of the signal unit of the present invention.

FIG. 5 is a flow showing the steps and functionality of the method and software product of the present invention.

### DETAILED DESCRIPTION

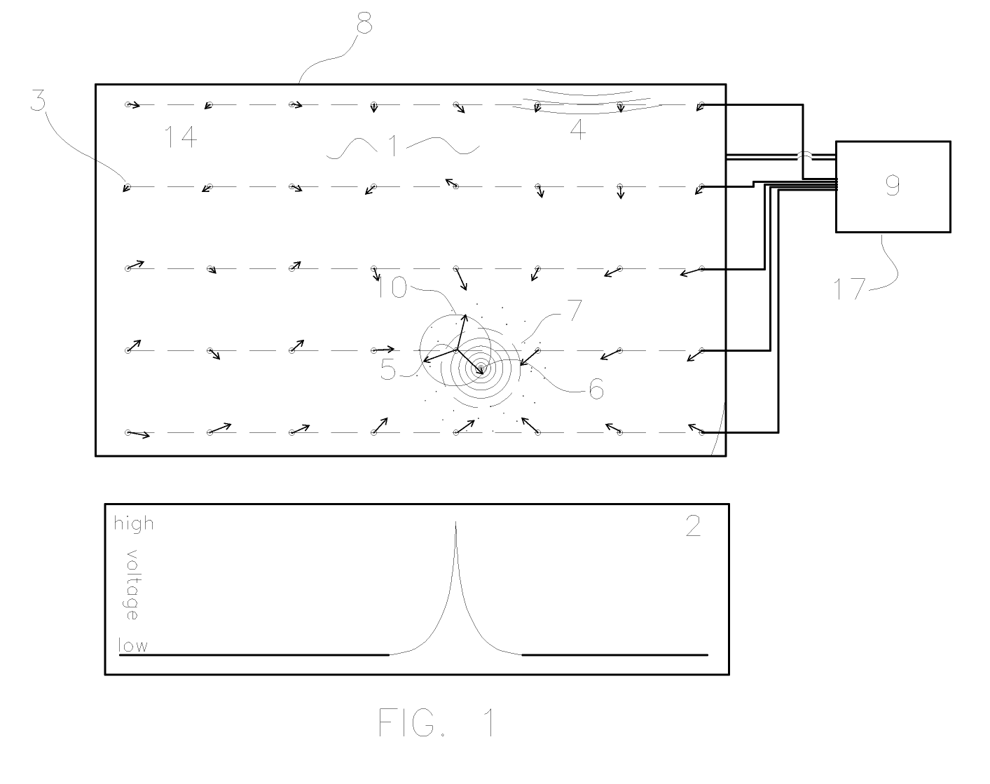

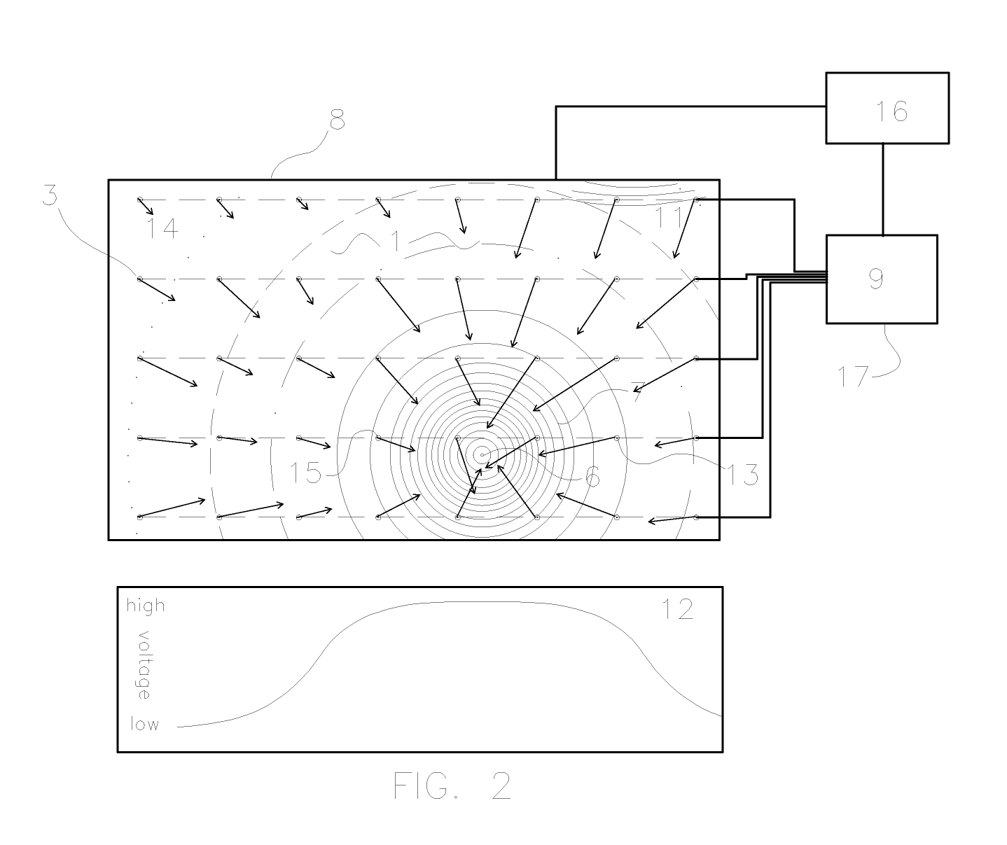

Referring first to FIG. 1, a plan view of a roof or waterproofing installation using low voltage is provided. Sensors 3 are covered by a non-conductive roofing or waterproofing membrane 1. Collectively, sensors 3 form a sensor array. In FIG. 1, membrane 1 overlays the conductive felt or grid 14 which is in intimate contact with the sensor array. It is understood that in other embodiments, sensors 3 may be on top of membrane 1. A signal generator 8, which is an impulse cable, provides the voltage signal 4 to the upper surface of the membrane 1. A computer 9, which includes a hub assembly 17, indicates to the signal generator 8 that it should provide signal 4 to the membrane 1, and reads data gathered by the sensors 3. Although hub assembly 17 is shown as a physical element in FIGS. 1 and 2, it is understood that communication between computer 9 and sensors 3 and/or signal generator 8 may be wireless. In FIG. 1, the signal control capable of varying the voltage, frequency, or voltage and frequency of the signal is integrated into computer 9 or signal generator 8.

A representation of the electrical field 7 generated by the hole 6 in the membrane 1 and a voltage graph 2 below show how the voltage attenuates as the distance from the leak or hole 6 in the membrane increases. FIG. 1 demonstrates a low voltage scenario when the sensors 3 are spaced far apart. Most of the sensors 3 do not detect the low voltage signal 4, as the conductive substrate has already consumed the energy from the signal. One sensor 5 is close enough to the signal source (leak) 6 that it does receive the signal and reports this to the computer 9 when it is polled. In the absence of data from other sensors 3 in the area, however, the computer cannot know where the leak 6 is actually located, and a guess would encompass a circular area 10, the radius of which would be roughly the estimated distance that caused the measured attenuation in the signal 4. The graph 2 shows the attenuation of the electrical field from full voltage at the point of leakage 6 to null voltage at some distance from the point of leakage.

Now referring to FIG. 2, a plan view of a roof or waterproofing installation using high voltage is presented. Again, sensors 3 are covered by a non-conductive membrane 1 and conductive felt or mesh 14. Signal generator 8, which is an impulse cable in this embodiment, provides the different and distinct, higher voltage or frequency signal 11, to the upper surface of the membrane 1. Computer 9, which includes a hub assembly 17, indicates to signal generator 8 that it should provide to membrane 1 a distinct signal 11, and reads data gathered by the sensors 3. In FIG. 2, signal control 16 is separate element from both computer 9 and signal generator 8. In the embodiment shown, signal control 16 receives an indication from computer 9 as to the nature of the signal 11 to be provided by signal generator 8, and enables the signal generator 8 to provide such a signal 11.

A representation of the electrical field 7 generated by the hole 6 in the membrane 1 and a voltage graph 12 below show how the voltage attenuates as the distance from the leak or hole 6 in the membrane increases. FIG. 2 demonstrates a different and distinct signal scenario when the sensors 3 are spaced far apart. Many of the sensors 3 detect the signal 11 as there is enough energy contained in the signal 11 to overcome the resistance of the conductive substrate near the hole, and attenuation of the signal 11 occurs further away from the leak, in the body of the sensor field. Three sensors 5, 13, 15 are close enough to the signal source (leak) 6 that they report virtually the same voltage to the computer 9 when they are polled. As a result, the computer 9 cannot reliably triangulate the location of the leak from these three sensors 5, 13, 15, and uses other, further sensors which are able to measure the decay in the signal for triangulation. This triangulation can point to the general area of the leakage, but the area is broad enough because of the sensor spacing that the leak might not be found, especially under overburdens and pavers. The graph 12 shows the attenuation of the electrical field from full voltage at the point of leakage 6 to null voltage at some distance from the point of leakage.

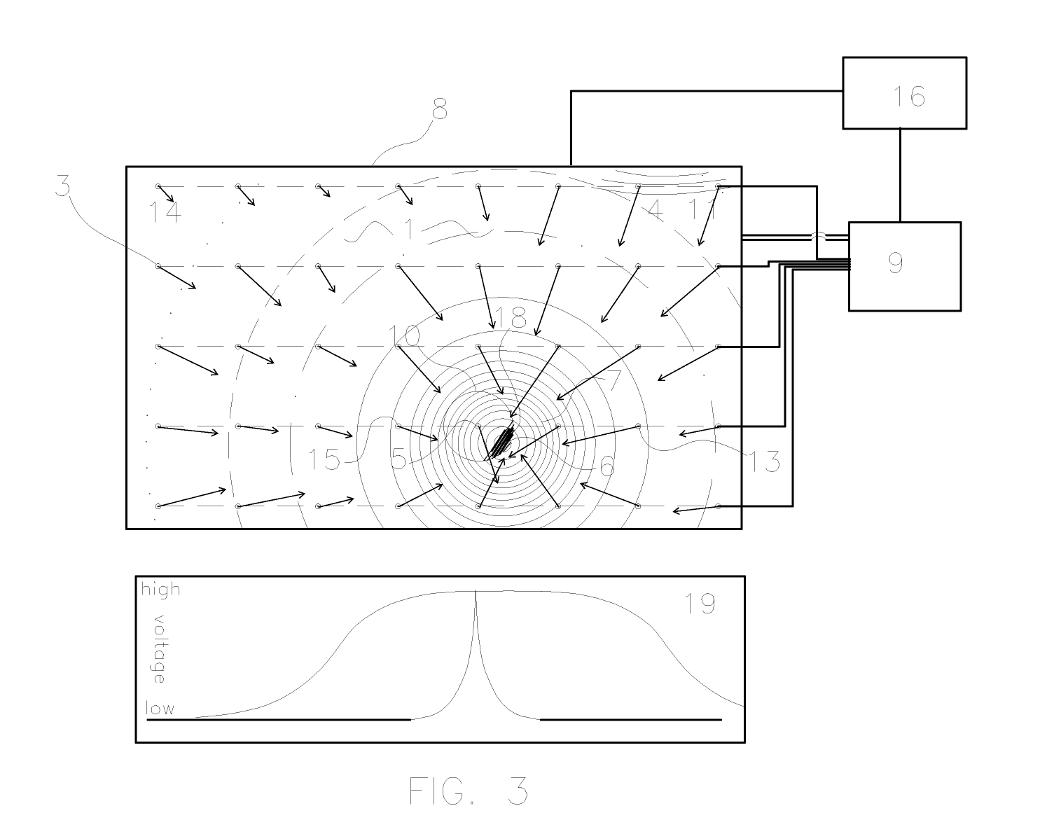

Now referring to FIG. 3, a plan view of a roof or waterproofing installation using the two signals 4, 11 together is provided. The low energy or frequency signal 4 allows any sensors near the leak to measure the attenuation of that signal, and the high energy signal 11 allows sensors further away to measure the attenuation of that signal. The graph 19 at the bottom of the page shows how the slopes of the attenuation of the different and distinct signals overlap to provide meaningful and measurable readings that the computer can use to make accurate triangulations to locate leakage. The cross-hatched area 18 indicates the approximate location of the leak based on the triangulations from the different readings.

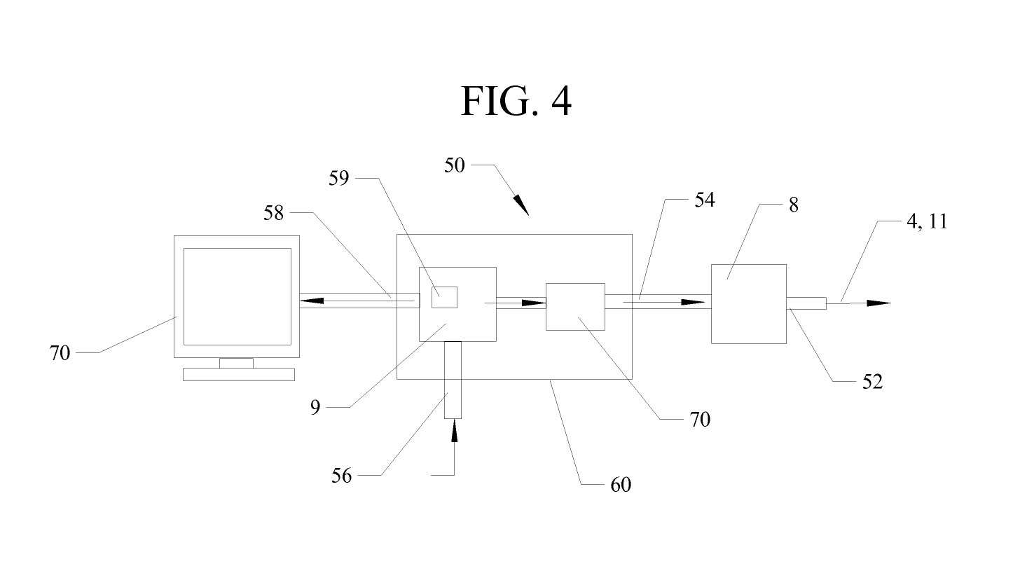

Now referring to FIG. 4, one embodiment of the signal unit 50 of the present invention shown. Signal unit 50 includes computer 9 and signal control 16 disposed within a housing 60. Housing 60 is preferably dimensioned to be handheld, although the housing may take the form of a laptop computer case, CPU housing, or any other art recognized means of housing electronic components. Computer 9 is in electrical communication with signal control 16, which sends an instruction to signal generator 8. In the embodiment of FIG. 4, this signal is sent though output 54 to signal generator 9, which receives the instruction signal from the signal control 16 and send signals 4,11 though a signal output 52. However, in other embodiments, signal generator 8 is integrated into the signal unit an output 54 is eliminated. Computer 9 is in communication with an input 56, which provides information from sensors. These sensors may be the sensors of the system of the present invention or may be other types of sensors known in the prior art. In the embodiment of FIG. 4, the computer also sends a signal though output 58 to a display 70. However, in other embodiments, display 70 is integrated into the housing 60 and the output 58 is either eliminated or is utilized as a data output to store data from the testing performed by the signal unit. The computer 9 of the signal unit 60 has a memory 59 into which a software product is stored, although in other embodiments the software product is stored it the signal control 16, while in still others, it is stored in a memory 59 that is not part of the computer 9. The software product performs at least the functions of sending a signal to the signal control instructing the signal generator 8 to generate specific signals and determining if a sufficient data has been received to determinate the presence and location of a leak. However, the software product preferably controls the performance of all of the steps of the method 100 described below.

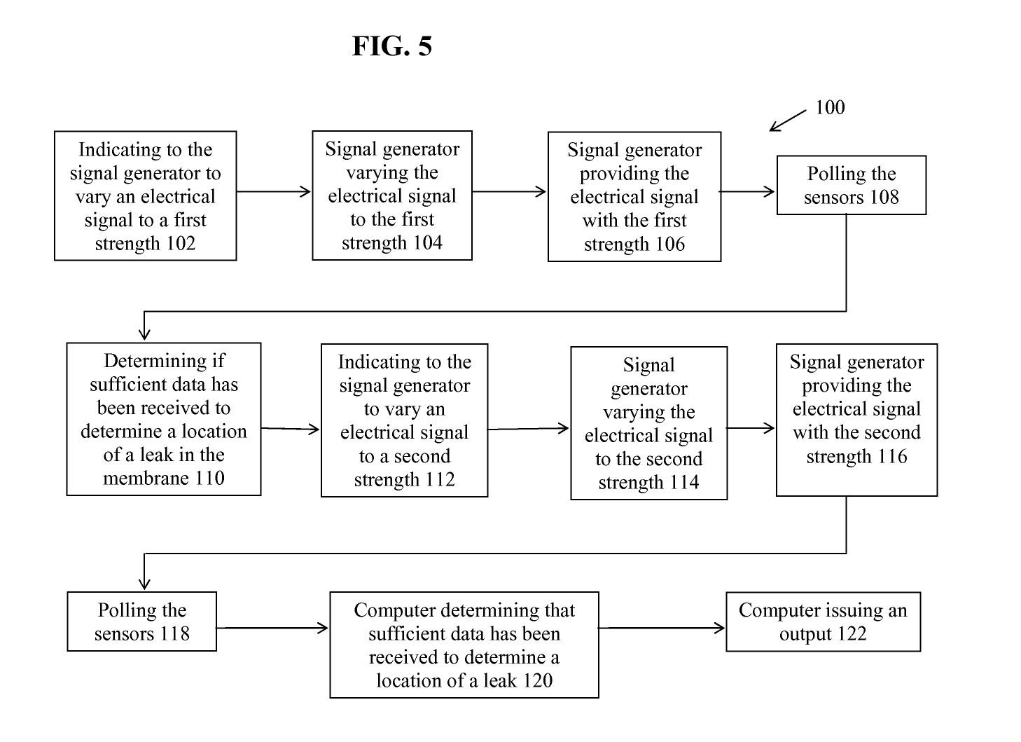

Now referring to FIG. 5, the steps of method 100 of the present invention are shown. They include: the computer indicating to the signal control to vary an electrical signal to a first strength 102; the signal control varying the electrical signal to the first strength 104; the signal generator providing the electrical signal with the first strength to the membrane 106; the computer polling the sensors for the electrical signal strength at the positions of the sensors on the membrane 108; the computer determining that insufficient data has been received to determine a location of a leak in the membrane 110; the computer indicating to the signal control to vary an electrical signal to a second strength 112, where the second strength is distinct from the first strength; the signal control varying the electrical signal to the second strength 114; the signal generator providing the electrical signal with the second strength to the membrane 116; the computer polling the sensors for the electrical signal strength at the positions of the sensors on the membrane 118; the computer determining that sufficient data has been received to determine a location of a leak in the membrane 120; and the computer issuing an alert indicating the presence and location of the leak 122.

The first and second strengths mentioned in the steps of method 100 may refer to voltage or frequency or voltage and frequency. In a preferred method, the first strength is 7 v and the second strength is 15 v. Voltage should not exceed 58 v. The voltage or frequency used may be a function of what the membrane is made of An asphalt membrane, for example, will have little or no conductivity and therefore would require a very strong signal so as to account for very fast attenuation. A metal membrane, on the other hand, may be very conductive and therefore require lower strength signals to measure attenuation.

In some embodiments of method 100, the electrical signal is not turned off between polling, but only varied in strength. In some embodiments, only the sensors that indicated they were near a membrane breach and other sensors near those sensors are polled a second time after the second signal. The sensors are polled until sufficient data is received to locate the leak. In some embodiments, more than two signals are required to determine the presence and location of a leak. If the first signal is provided and no sensor reads the signal, for example, additional stronger signals may be provided until at least one sensor reads the signal, indicating a leak. The second signal may then be provided so that the two may be compared. In addition, even when at least one sensor does detect the signal, polling after the second signal may not provide sufficient information to locate the leak. In such situations, a third signal may be provided.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. A system for detecting and locating a leak in a membrane, comprising:
a plurality of sensors arranged in a grid corresponding to an area to be tested on the membrane, wherein said sensors are capable of reading a strength of an electrical signal at a position of said sensors on the membrane;
a computer in electrical communication with said sensors such that said computer is able to receive electrical signal strength readings from each of said plurality of sensors;
a signal generator capable of providing an electrical signal to the membrane, wherein said signal generator is in electrical communication with said computer;
a signal control capable of instructing said signal generator to vary the strength of an electrical signal, wherein said signal control is in electrical communication with said computer and said signal generator;
wherein said computer indicates to said signal control the strength of the electrical signal to be provided to the membrane;
wherein said signal control instructs said signal generator to vary the strength of the electrical signal when necessary to conform to the indication of said computer; and
wherein said signal generator provides an electrical signal to the membrane having a strength as instructed by said signal control.

2. The system as claimed in claim 1, wherein said signal control is integrated with said computer.

3. The system as claimed in claim 1, wherein said signal control and said signal generator are integrated with said computer

4. The system as claimed in claim 1, wherein said sensors are spaced between 12 and 60 feet from one another.

5. The system as claimed in claim 1, further comprising a hub assembly capable of physically connecting said computer with at least one of said signal control, said signal generator, and said plurality of sensors.

6. The system as claimed in claim 1, wherein said signal generator is an impulse cable disposed proximate to said plurality of sensors such that a signal provided by said impulse cable to the membrane is readable by at least one of said plurality of sensors.

7. The system as claimed in claim 1, wherein the strength of the electrical signal is measured in terms of at least one of voltage and frequency.

8. The system as claimed in claim 1, further comprising a conductive medium disposed under the membrane and in physical contact with said plurality of sensors.

9. A signal unit for use in a system for detecting and locating a leak in a membrane, said system comprising at least two sensors, said signal unit comprising:
a computer in electrical communication with each of said sensors such that said computer is able to receive electrical signal strength readings from each of the sensors;
a signal control capable of instructing a signal generator to vary a strength of an electrical signal, wherein said signal control is in electrical communication with said computer and the signal generator; and
computer software means for controlling a strength of the electrical signal to be provided to the membrane by the signal generator and for determining whether sufficient data has been received to determine a location of a leak in the membrane.

10. The signal unit as claimed in claim 9 further comprising said signal generator.

11. The signal unit as claimed in claim 9, wherein said computer software means for controlling a strength of the electrical signal to be provided to the membrane by the signal generator and for determining whether sufficient data has been received to determine a location of a leak in the membrane comprises:
software means for indicating to said signal control to vary an electrical signal to a first strength;
software means for accepting data from each from each of the sensors and determining that said data is insufficient to determine the location of the leak in the membrane;
software means for indicating to said signal control to vary an electrical signal to a second strength, wherein said second strength is distinct from the first strength; and
software means for accepting data from each from each of the sensors and determining that said data is sufficient to determine the location of the leak in the membrane.

12. The signal unit as claimed in claim 11, wherein said computer software means for controlling a strength of the electrical signal to be provided to the membrane by the signal generator and for determining whether sufficient data has been received to determine a location of a leak in the membrane further comprises software means for issuing an alert indicating the presence and location of the leak.

13. The signal unit as claimed in claim 11, wherein said computer software means for controlling a strength of the electrical signal to be provided to the membrane by the signal generator and for determining whether sufficient data has been received to determine a location of a leak in the membrane further comprises software means for sending a signal to a display that displays the location of the leak.

14. The signal unit as claimed in claim 11, wherein said computer software means for controlling a strength of the electrical signal to be provided to the membrane by the signal generator and for determining whether sufficient data has been received to determine a location of a leak in the membrane further comprises software means for determining appropriate electrical signal strengths based upon a conductivity of a material out of which the membrane is made.

15. The signal unit as claimed in claim 11, wherein said computer software means for controlling a strength of the electrical signal to be provided to the membrane by the signal generator and for determining whether sufficient data has been received to determine a location of a leak in the membrane further comprises software means for providing an electrical signal of substantially continuous variable strength when varying said electrical signal between said first strength and said second strength.

16. A method for detecting and locating a leak in a membrane, wherein said method is performed by a system comprising a plurality of sensors arranged in a grid on the membrane, wherein the sensors are spaced between 12 and 60 feet from one another, and the sensors are capable of reading a strength of an electrical signal at a position of the sensors on the membrane; a computer in electrical communication with the sensors such that the computer is able to receive electrical signal strength readings from each of the plurality of sensors; a signal generator capable of providing an electrical signal to the membrane, wherein the signal generator is in electrical communication with the computer; a signal control capable of varying the strength of an electrical signal, wherein the signal control is in electrical communication with the computer and the signal generator; wherein the computer indicates to the signal control the strength of the electrical signal to be provided to the membrane; wherein the signal control varies the strength of the electrical signal when necessary to conform to the indication of the computer; and wherein the signal generator provides an electrical signal to the membrane having a strength as indicated by the computer, said method comprising the steps of:
the computer indicating to the signal control to vary an electrical signal to a first strength;
the signal control varying the electrical signal to the first strength;
the signal generator providing the electrical signal with the first strength to the membrane;
the computer first polling the sensors for the electrical signal strength at the positions of the sensors on the membrane;
the computer determining that insufficient data has been received to determine a location of a leak in the membrane;
the computer indicating to the signal control to vary an electrical signal to a second strength, wherein the second strength is distinct from the first strength;
the signal control varying the electrical signal to the second strength;
the signal generator providing the electrical signal with the second strength to the membrane;
the computer second polling the sensors for the electrical signal strength at the positions of the sensors on the membrane;
the computer determining that sufficient data has been received to determine a location of a leak in the membrane; and
the computer issuing an alert indicating the presence and location of the leak.

17. The method as claimed in claim 16, wherein the first strength is one of a first voltage and a first frequency and the second strength is one of a second voltage and a second frequency.

18. The method as claimed in claim 16, wherein the first strength and second strength are each no greater than 58 v.

19. The method as claimed in claim 16, further comprising the step of the computer determining appropriate electrical signal strengths to indicate to the signal control based on a conductivity of a material out of which the membrane is made.

20. The method as claimed in claim 16, wherein said step of second polling said sensors comprises polling only the sensors that read an electrical signal strength during said step of first polling said sensors and sensors proximate to said sensors that read an electrical signal strength during said step first polling.

21. The method as claimed in claim 16, further comprising steps of:
the computer indicating to the signal control to vary an electrical signal to a third strength, wherein the third strength is greater than the first strength and less than the second strength;
the signal control varying the electrical signal to the third strength;
the signal generator providing the electrical signal with the third strength to the membrane; and
the computer polling the sensors for the electrical signal strength at the positions of the sensors on the membrane.
